(19) United States
(12) Patent Application Publication
(10) Pub. No.: US 2024/0405392 A1
(43) Pub. Date: Dec. 5, 2024

(54) ELECTRODE ASSEMBLY AND RECHARGEABLE LITHIUM BATTERY INCLUDING THE SAME

(71) Applicant: SAMSUNG SDI CO., LTD., Yongin-si (KR)

(72) Inventor: DONG MYUNG LEE, Yongin-si (KR)

(21) Appl. No.: 18/605,937

(22) Filed: Mar. 15, 2024

(30) Foreign Application Priority Data
Jun. 1, 2023 (KR) 10-2023-0071112

(51) Int. Cl. H01M 50/586; H01M 10/052; H01M 10/0585

(52) U.S. Cl. CPC H01M 50/586; H01M 10/052; H01M 10/0585

(57) ABSTRACT

An electrode assembly includes a first short-circuit member, an anode on the first short-circuit member, the anode including a first substrate and a first active material layer on the first substrate, a separator on the anode, a cathode on the separator, the cathode including a second substrate and a second active material layer on the second substrate, and a second short-circuit member on the cathode, wherein each of the first short-circuit member and the second short-circuit member includes a first metal foil, an insulating layer, and a second metal foil that are on top of each other.

### CROSS-REFERENCE TO RELATED APPLICATION

This application claims priority to and the benefit of Korean Patent Application No. 10-2023-0071112, filed in the Korean Intellectual Property Office on Jun. 1, 2023, the entire contents of which are incorporated herein by reference.

### BACKGROUND

### 1. Field

The present disclosure relates to an electrode assembly, and particularly, to an electrode assembly for a rechargeable battery and a rechargeable battery including the same.

### 2. Description of the Related Art

The demand for rechargeable batteries as an energy source is increasing with the development of technology for mobile devices. The rechargeable battery, unlike a primary battery, is a battery that can be repeatedly charged and discharged.

### SUMMARY

An embodiment of the present disclosure provides an electrode assembly which includes: a first short-circuit member; an anode constituted by a first substrate located on the first short-circuit member, and a first active material layer formed on the first substrate; a separator overlapped with the anode; a cathode constituted by a second substrate located on the separator, and a second active material layer formed on the second substrate; and a second short-circuit member located on the cathode, in which a first metal foil, an insulating layer, and a second metal foil are stacked in each of the first short-circuit member and the second short-circuit member.

The first metal foil may be made of the same metal as the first substrate, and may be stronger than the first substrate, and the second metal foil may be made of the same metal as the second substrate, and may be stronger than the second substrate.

The first metal foil may be thicker than the first substrate, and the second metal foil may be thicker than the second substrate.

A thickness of the first metal foil may be 6 μm to 10 μm, and a thickness of the second metal foil may be 15 μm to 20 μm.

The first metal foil may be made of copper, and the second metal foil may be made of aluminum.

The first short-circuit member and the second short-circuit member may be larger than the anode and the cathode, and may be protruded out of a boundary line of the anode and the cathode in an overlapped state.

A bending line may be formed in the first short-circuit member and the second short-circuit member, and the first short-circuit member and the second short-circuit member may be bent along the bending line.

The first metal foil may be located on surfaces of the firs fixation member and the second fixation member which face each other.

The first electrode, the separator, and the second electrode may have a sheet type, and may be alternatively repeatedly stacked.

The first metal foil may be directly between the insulating layer and the separator.

The second metal foil of each of the first short-circuit member and the second short-circuit member may face and contact an exterior of the electrode assembly.

Edges of each the first short-circuit member and the second short-circuit member may be bent toward the anode and cathode, respectively.

Another embodiment of the present disclosure provides a rechargeable lithium battery which includes: the electrode assembly; and a case receiving the electrode assembly and an electrolyte.

### BRIEF DESCRIPTION OF THE DRAWINGS

Features will become apparent to those of skill in the art by describing in detail exemplary embodiments with reference to the attached drawings, in which:

FIG. 1 is a schematic exploded perspective view of an electrode assembly according to an embodiment of the present disclosure.

FIG. 2 is a schematic cross-sectional view of the electrode assembly of FIG. 1.

FIG. 3 is a diagram for describing a penetration test of an electrode assembly according to an embodiment of the present disclosure.

FIG. 4 is a schematic cross-sectional view of an electrode assembly according to another embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise”, and variations such as “comprises” or “comprising”, will be understood to imply the inclusion of stated elements but not the exclusion of any other elements.

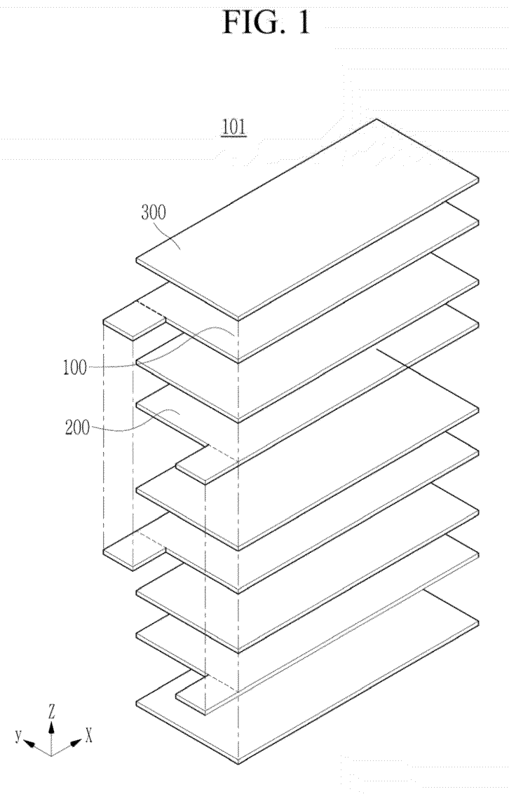

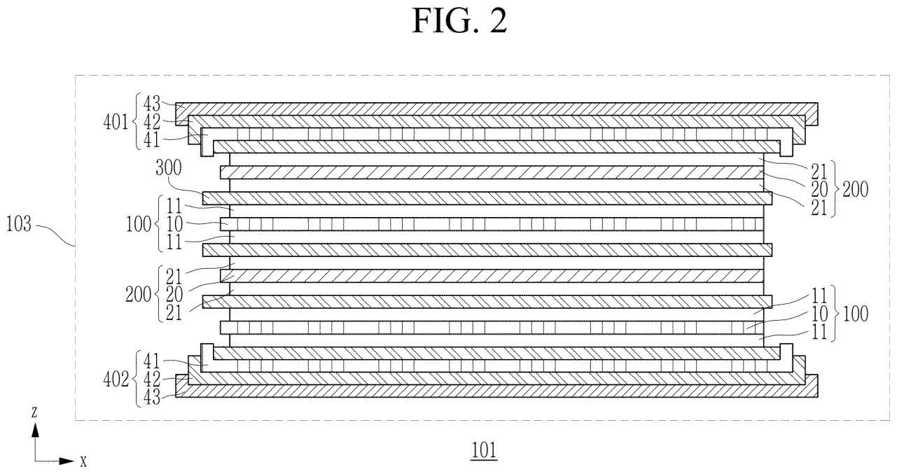

FIG. 1 is a schematic exploded perspective view of an electrode assembly according to an embodiment of the present disclosure, and FIG. 2 is a schematic cross-sectional view of the electrode assembly of FIG. 1.

As illustrated in FIGS. 1 and 2, an electrode assembly 101 according to an embodiment of the present disclosure may be a stacked electrode assembly, in which a sheet type anode 100, a sheet type cathode 200, and a sheet type separator 300 may be provided. Each of the anode 100 and the cathode 200 may have a sheet shape, and the separator 300 may be interposed between the anode 100 and the cathode 200. A structure of the anode 100 and the cathode 200 with the separator 300 therebetween may be repeatedly positioned.

The anode 100 may include a first electrode activation portion, i.e., a portion in which an anode active material layer 11 is formed on an anode substrate 10 formed by a metal foil, and a first electrode uncoated portion, i.e., a portion where the anode substrate 10 is exposed through an active material (e.g., the active material is not applied).

The active material that forms the anode active material layer 11 of the anode 100 may include a compound capable of reversible intercalation and deintercalation of lithium (e.g., a lithiated intercalation compound). For example, one or more composite oxides of metal, e.g., cobalt, manganese, nickel, and combinations thereof, and lithium may be used. The content of an anode active material may be 90 wt % to 98 wt %, based on a total weight of the anode active material layer 11.

The anode active material layer 11 may further include a binder and a conductive material. In this case, the content of each of the binder and the conductive material may be 1 wt % to 5 wt %, based on the total weight of the anode active material layer 11.

The binder serves to bind anode active material particles to each other, and also to bind the anode active material to a substrate (which is a current collector). Examples of the binder may include polyvinyl alcohol, carboxymethylcellulose, hydroxypropyl cellulose, diacetyl cellulose, diacetyl cellulose, polyvinyl chloride, carboxylized polyvinyl chloride, polyvinyl fluoride, polymer containing ethylene oxide, polyvinyl pyrrolidone, polyurethane, polytetrafluoroethylene, polyvinylidene fluoride, polyethylene, polypropylene, styrene butadien rubber, acrylated styrene butadiene rubber, epoxy resin, nylon, etc. The conductive material is used for assigning conductivity to an electrode, and any suitable conductive material that does not cause a chemical change may be used.

The cathode 200 may include a first electrode activation portion, i.e., a portion in which a cathode active material layer 21 is formed on a cathode substrate 20 formed by a metal foil having conductivity, e.g., copper (Cu), and a second electrode uncoated portion, i.e., a portion where the cathode substrate 20 is exposed through the active material (e.g., the active material is not applied).

A cathode active material included in the cathode active material layer 21 of the cathode 200 may be a carbon-based active material. For example, the carbon-based active material may be artificial graphite or a mixture of artificial graphite and natural graphite. When artificial graphite or a crystalline carbon-based material (e.g., a mixture of artificial graphite and natural graphite) is used as the cathode active material, crystalline characteristics of particles are further developed compared to an amorphous carbon-based active material, so orientation characteristics of a carbon material in a pole plate for an external magnetic field may be further enhanced. The form of the artificial graphite or the natural graphite may be amorphous, plate, flake, spherical, fibrous type, or a combination thereof. Further, when the artificial graphite and the natural graphite are mixed, a mixture ratio of the artificial graphite to the natural graphite may be 70:30 wt % to 95:5 wt %.

Further, the cathode active material layer may further include at least one of an Si-based cathode active material, an Sn-based cathode active material, or a LiMOₓ(M=metal)-based cathode active material. When the cathode active material layer further includes the Si-based cathode active material, the Sn-based cathode active material, or the LiMOₓ (M=metal)-based cathode active material (i.e., when the cathode active material layer includes a carbon-based cathode active material as a first cathode active material and an additional cathode active material as a second cathode active material), a mixture ratio of the first cathode active material and the second cathode active material may be a weight ratio of 50:50 to 99:1.

The LiMOₓ (M=metal)-based cathode active material may be, e.g., a lithium vanadium oxide. The Si-based cathode active material may be, e.g., Si, Si—C complex, SiOₓ (0<x<2), Si-Q alloy (the Q is an alkaline metal, an alkaline earth metal, 13-group element, 14-group element, 15-group element, 16-group element, transition metal, rare earth element, or a combination thereof, and not Si). The Sn-based cathode active material may be, e.g., Sn, SnO₂, Sn—R alloy (the R is an alkaline metal, an alkaline earth metal, 13-group element, 14-group element, 15-group element, 16-group element, transition metal, rare earth element, and a combination thereof, and not Sn). For example, the Si-based cathode active material and the Sn-based cathode active material may also be used by mixing at least one thereof and SiO₂. As the elements Q and R, any of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof may be used.

The content of the cathode active material in the cathode active material layer 21 may be 95 wt % to 99 wt %, based on a total weight of the cathode active material layer 21.

The cathode active material may include a binder, and also selectively further include a conductive material. The content of the binder in the cathode active material may be 1 wt % to 5 wt %, based on the total weight of the cathode active material. Further, when the cathode active material further includes the conductive material, the cathode active material may be used in in an amount of 90 wt % to 98 wt %, the binder may be used in an amount of 1 wt % to 5 wt %, and the conductive material may be used in an amount of 1 wt % to 5 wt %, based on the total weight of the cathode active material layer 21.

The binder serves to bind cathode active material particles to each other, and also to bind the cathode active material to a cathode substrate. The binder may be a non-aqueous binder, an aqueous binder, or a combination thereof.

Examples of the non-aqueous binder may include polyvinyl chloride, carboxylized polyvinyl chloride, polyvinyl fluoride, polymer containing ethylene oxide, polyvinyl pyrrolidone, polyurethane, polytetrafluoroethylene, polyvinylidene fluoride, polyethylene, polypropylene, polyamideimide, polyimide, or a combination thereof. Examples of the aqueous binder may include styrene-butadien rubber, acrylated styrene-butadien rubber (SBR), acrylonytril-butadien rubber, acrylic rubber, butyl rubber, ethylenepropylene copolymer, polyepichlorohydrin, polyphosphazene, polyacrylonitrile, polystyrene, ethylene propylene diene copolymer, polyvinyl pyridine, chlorosulphonated polyethylene, polyethylene, latex, polyester resin, acrylic resin, phenol resin, epoxy resin, polyvinyl alcohol, acrylate-based resin, or a combination thereof.

When the aqueous binder is used as the cathode binder, the aqueous binder may further include a cellulose-based compound that may give viscosity as a thickener. Examples of the cellulose-based compound may include carboxymethyl cellulose, hydroxypropyl methyl cellulose, methyl cellulose, or a mixture of one or more of alkaline metal salt thereof. As the alkaline metal, Na, K, or Li may be used. The thickener content may be 0.1 parts by weight to 3 parts by weight, based on 100 parts by weight of the cathode active material.

The conductive material is used for assigning conductivity to an electrode, and any suitable conductive material that does not cause a chemical change may be used. Examples of the conductive material may include a conductive material containing carbon-based materials, e.g., natural graphite, artificial graphite, carbon black, acetylene black, ketjen black, carbon fiber, etc., metal-based materials, e.g., copper, nickel, aluminum, silver, etc., a conductive polymer, e.g., polyphenylene derivative, etc., or a mixture thereof.

Meanwhile, a BET specific surface area of the cathode active material layer 21 may be less than 3.0 m²/g, e.g., 0.6 m²/g to 1.2 m²/g. When the BET specific surface area of the cathode active material layer 21 is less than 3.0 m²/g, electrochemical life characteristics of the cell may be improved. In the BET measurement, a rechargeable lithium battery including the cathode is charged and discharged, and then a cathode obtained by dismantling a battery in a complete discharged state is cut in a predetermined size and put in a BET sample holder, and measured by a nitrogen gas adsorption method.

The cathode may have a cross-sectional loading level (L/L) of 6 mg/cm² to 65 mg/cm².

The separator 300 may be a polymer film that passes lithium ions. Examples of the polymer film may include polyethylene, polypropylene, poly vinylidene fluoride, or multi-layers of two or more layers thereof, and may include mixed multi-layers such as a 2-layer separator of polyethylene/polypropylene, a 3-layer separator of polyethylene/polypropylene/polyethylene, a 3-layer separator of polypropylene/polyethylene/polypropylene, etc. The separator 300 may be formed to be larger than the cathode 200 and the anode 100, and may protrude out of, e.g., beyond, the cathode 200 and the anode 100.

The first electrode uncoated portion and second electrode uncoated portion of the anode 100 and the cathode 200, which are repeatedly stacked, may be electrically connected to an external terminal while the same polarities are electrically connected. For example, the first electrode uncoated portion of the anode 100 and the second electrode uncoated portion of the cathode 200 may protrude in the same direction while being spaced apart from each other. In another example, the first electrode uncoated portion of the anode 100 and the second electrode uncoated portion of the cathode 200 may protrude in different directions.

The electrode assembly 101 may be received in a case 103, e.g., a pouch type or a can type case, jointly with an electrolyte and used as a rechargeable battery.

The electrolyte may include a non-hydrophilic organic solvent and lithium salt. The non-hydrophilic organic solvent serves as a medium in which ions involved in an electrochemical reaction of the battery may move.

The lithium salt is a material that is dissolved in the organic solvent, and acts as a supply source of the lithium ions in the battery. The lithium salt enables actuation of a basic rechargeable lithium battery, and serves to promote movement of the lithium ions between the anode and the cathode. A representative example of the lithium salt may include one or two or more of LiPF₆, LiBF₄, LiSbF₆, LiAsF₆, LiN(SO₂ C₂F₅)₂, Li(CF₃ SO₂)₂N, LiN(SO₃C₂Fₛ)₂, LiC₄F₉SO₃, LiClO₄, LiAlO₂, LiAlCl₄, LiN(CₓF₂ₓ₊₁ SO₂)(C_{y}F_{2y+1}SO₂) (x and y are natural numbers, e.g., integers of 1 to 20), LiCl, LiI, and LiB(C₂O₄)₂ (lithium bis(oxalato)borate (LiBOB)) as supporting electrolyte salt.

The concentration of the lithium salt in the electrolyte may be within the range of 0.1 M to 2.0 M. When the concentration of the lithium salt is included in the above range, the electrolyte has appropriate conductivity and viscosity, which may show excellent electrolyte performance, and the lithium ions may move effectively.

As illustrated in FIG. 2, a first short-circuit member 401 and a second short-circuit member 402 may be located at an outermost portion of the electrode assembly 101 (e.g., may face and contact an exterior of the electrode assembly 101) according to an embodiment of the present disclosure. For example, as illustrated in FIG. 2, a plurality of the anodes 100 and the cathode 200 may be stacked between the first short-circuit member 401 and the second short-circuit member 402. For example, each of the first and second short-circuit member 401 and 402 may be positioned between an interior sidewall of the case 103 and the stacked anodes 100 and cathodes 200. For example, as illustrated in FIG. 2, each of the first and second short-circuit member 401 and 402 may be parallel to the stacked anodes 100 and cathodes 200.

Each of the first short-circuit member 401 and the second short-circuit member 402 located at the outermost portion of the electrode assembly 101 may include a first metal foil 41 made of aluminum, e.g., a same material as the anode substrate 10 of the anode 100, an insulating layer 42, e.g., a same material as the separator 300, and a second metal foil 43 made of copper, e.g., a same material as the cathode substrate 20 of the cathode 200. For example, as illustrated in FIG. 2, the insulating layer 42 may be between (e.g., directly between) the first and second metal foils 41 and 43.

The first metal foil 41 may have a same thickness or may be thicker than the anode substrate 10 of the anode 100, and may be stronger than the anode substrate 10, e.g., may have a higher tensile strength and/or fatigue strength than the anode substrate 10. Further, the second metal foil 43 may be thicker and stronger than the cathode substrate 20 of the cathode 200, e.g., may have a higher tensile strength and/or fatigue strength than the cathode substrate 20. For example, the second metal foil 43 may be thicker than the first metal foil 41. For example, a thickness of the first metal foil 41 may be 6 μm to 10 μm, and a thickness of the second metal foil 43 may be 15 μm to 20 μm. The second metal foil 43 is formed to be thicker than the cathode substrate 20 to form the short-circuit path more safely upon penetration. For example, each of the thicknesses of the anode substrate 10 and the cathode substrate 20 may be 6 μm to 8 μm.

The first metal foil 41 may be electrically connected to the anode 100, and the second metal foil 43 may be electrically connected to the cathode 200. For example, the first metal foil 41 may be welded to the first electrode uncoated portion of the anode and the second metal foil 43 may be welded to the second electrode uncoated portion.

The second metal foil 43 may be disposed relatively adjacent to the electrode assembly 101 (e.g., adjacent to an outermost side of the electrode assembly 101), and the first metal foil 41 may be located relatively far away from the electrode assembly 101 (e.g., farther from an outermost side of the electrode assembly 101 than the second metal foil 43 is), so that the first short-circuit member 401 and the second short-circuit member 402 are symmetric to each other around the electrode assembly 101. For example, as illustrated in FIG. 2, the first metal foil 41 may be adjacent to the stacked anodes 100 and cathodes 200, e.g., the separator 300 may be directly between the first metal foil 41 and an outermost one of the stacked anodes 100 and cathodes 200 on each side of the electrode assembly 101. For example, as illustrated in FIG. 2, a distance between the first metal foil 41 and an outermost separator 300 on each sides of the electrode assembly 101 may be smaller than a distance between the second metal foil 43 and the outermost separator 300 on a same side of the electrode assembly 101. For example, as illustrated in FIG. 2, the arrangement of the first and second metal foils 41 and 43 on opposite sides of the electrode assembly 101 may be symmetrical with respect to a central axis of the electrode assembly 101. The symmetrical arrangement of the first and second short-circuit members 401 and 402 may more quickly cause a short-circuit between the anode and cathode substrates 10 and 20, and a current path may be stably formed.

The first short-circuit member 401 and the second short-circuit member 402 may be larger (e.g., longer) than the anodes 100 and cathodes 200 in the electrode assembly 101, and may protrude out of a boundary line of the anode 100 and the cathode 200 of the electrode assembly 101 in an overlapped state. For example, as illustrated in FIG. 2, each of the first and second short-circuit members 401 and 402 may be longer than the stacked structure of the anodes 100 and cathodes 200 (with the separators 300 therebetween), such that each of the first and second short-circuit members 401 and 402 may extend beyond the stacked structure of the anodes 100 and cathodes 200 (with the separators 300 therebetween) at each side of the electrode assembly 101.

The first short-circuit member 401 and the second short-circuit member 402 protruding out of, e.g., beyond, the stacked anodes 100 and cathodes 200 of the electrode assembly 101 may be bent in a direction to face each other. For example, as illustrated in FIG. 2, opposite outer edges in a longitudinal direction (e.g., X direction) of each of the first and second short-circuit members 401 and 402 may be bent toward the stacked anodes 100 and cathodes 200 (e.g., in the Z direction). In another example, opposite outer edges in the Y direction of each of the first and second short-circuit members 401 and 402 may be bent toward the stacked anodes 100 and cathodes 200. For example, as further illustrated in FIG. 2, the first metal foil 41 may be bent at opposite sides thereof to completely cover opposite lateral surfaces of the separator 300 adjacent thereto, and the insulating layer 42 and the second metal foil 43 may be sequentially bent to partially cover the first metal foil 41 and the insulating layer 42, respectively. This is to protect a periphery of the electrode assembly 101 from shocks. In this case, in order to facilitate bending, a bending line may be formed in the first short-circuit member 401 and the second short-circuit member 402. The bending line may be a groove formed on one surface of each of the first metal foil 41 and the second metal foil 43. The groove may be formed to be continuously formed along one side of the electrode assembly 101 or non-continuously formed at a predetermined interval.

As in an embodiment of the present disclosure, when the short-circuit members 401 and 402 are formed at each of both sides of the electrode assembly 101 (e.g., at opposite sides of the electrode assembly 101 in the Z direction), the short-circuit path may be easily formed upon penetration shock.

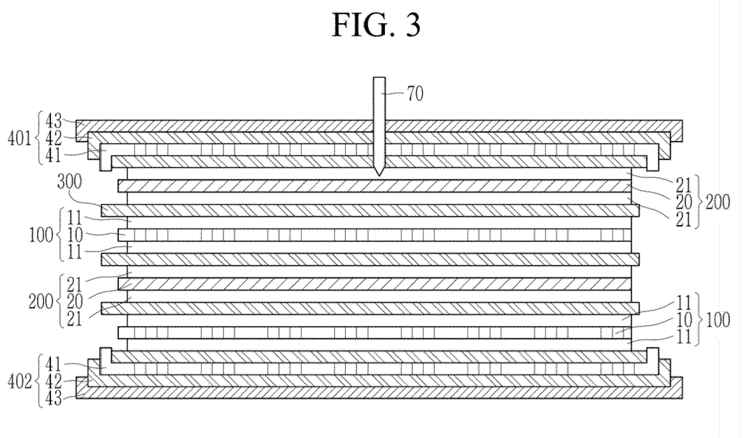

FIG. 3 is a diagram for describing a penetration test of the electrode assembly according to an embodiment of the present disclosure.

Referring to FIG. 3, in a penetration test, a penetration member 70 (e.g., a nail) penetrates the electrode assembly, e.g., the first short-circuit member 401, the separator 300, and at least a portion of the cathode 200. The penetration member 70 may form a short-circuit path by penetrating the electrode assembly.

The penetration member 70 electrically connects the first metal foil 41 and the second metal foil 43, while penetrating the first short-circuit member 401, to quickly form the short-circuit path. In an embodiment of the present disclosure, only the insulating layer 42 is located between the first metal foil 41 and the second metal foil 43, thereby inducing a short-circuit more quickly and easily, e.g., as compared to short-circuiting the anode and the cathode requiring passing through an active material layer on top of the substrate.

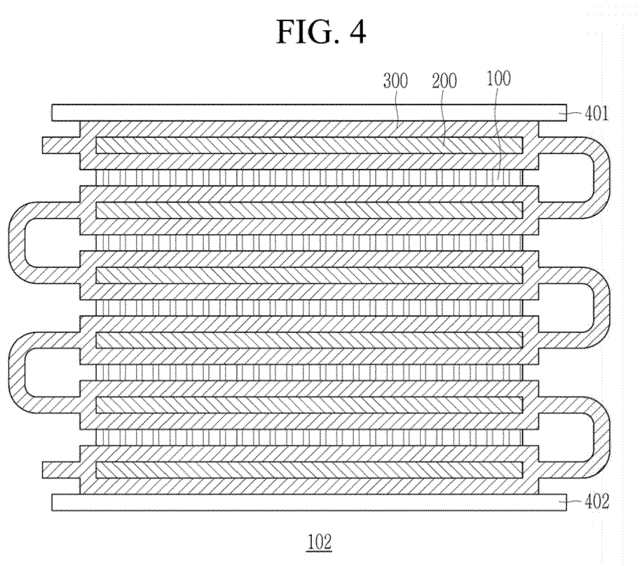

FIG. 4 is a schematic cross-sectional view of an electrode assembly according to another embodiment of the present disclosure. The electrode assembly of FIG. 4 is substantially the same as the electrode assembly of FIG. 1, and therefore, only different parts will be described in detail below.

Referring to FIG. 4, in an electrode assembly 102, the anodes 100 and the cathodes 200 may be alternately stacked with the separators 300 interposed therebetween. Further, a first fixation member 501 and a second fixation member 502 may be located at an outermost portion of the stacked structure of the anodes 100 and cathodes 200, e.g., the first and second fixation members 501 and 502 may be positioned at opposite sides of the electrode assembly 102. The first and second fixation members 501 and 502 may be between the stacked structure of the anodes 100 and cathodes 200 and the first and second short-circuit member 401 and 402, respectively, of FIG. 2.

The separator 300 may have a receiving portion to be inserted with each cathode 200 and to cover the entirety of the periphery of the cathode 200. The receiving portion may have a larger volume than the cathode 200. The receiving portion may be bonded to the separator 300 at a predetermined interval which is as large as a size of the cathode 200 to form the receiving portion. The separator 300 may be repeatedly bent in a continuous strip form, and the anode 100 may be positioned to be overlapped between the receiving portions.

By way of summation and review, a rechargeable battery may be ignited, may be ruptured, and/or may explode in response to external shocks or penetration shocks, thereby requiring appropriate safety devices. For example, short circuit current may be generated due to penetrating impacts caused by pointed objects, thereby triggering ignition. Therefore, it is desired to quickly disperse thermal energy generated by the short circuit current in the event of penetration.

In contrast, the present disclosure provides an electrode assembly and a rechargeable lithium battery including the same, which can quickly form a short-circuit path and quickly discharge heat even if penetration occurs. That is, according to the present disclosure, when a metal foil is added to an outermost portion of an electrode assembly, heat is quickly discharged while a short-circuit is formed to provide an electrode assembly and a rechargeable battery which are safe.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a first short-circuit member;
an anode on the first short-circuit member, the anode including a first substrate and a first active material layer on the first substrate;
a separator on the anode;
a cathode on the separator, the cathode including a second substrate and a second active material layer on the second substrate; and
a second short-circuit member on the cathode,
wherein each of the first short-circuit member and the second short-circuit member includes a first metal foil, an insulating layer, and a second metal foil that are on top of each other.

2. The electrode assembly of claim 1, wherein:
the first metal foil includes a same metal as the first substrate, the first metal foil being stronger than the first substrate, and
the second metal foil includes a same metal as the second substrate, the second metal foil being stronger than the second substrate.

3. The electrode assembly of claim 2, wherein:
the first metal foil is thicker than the first substrate, and
the second metal foil is thicker than the second substrate.

4. The electrode assembly of claim 3, wherein:
a thickness of the first metal foil is 6 μm to 10 μm, and
a thickness of the second metal foil is 15 μm to 20 μm.

5. The electrode assembly of claim 1, wherein:
the first metal foil includes copper, and
the second metal foil includes aluminum.

6. The electrode assembly of claim 1, wherein each of the first short-circuit member and the second short-circuit member are longer than each of the anode and the cathode, each of the first short-circuit member and the second short-circuit member protruding beyond an edge of each of the anode and the cathode in an overlapped state.

7. The electrode assembly of claim 6, wherein each of the first short-circuit member and the second short-circuit member includes a bending line, each of the first short-circuit member and the second short-circuit member being bent along the bending line.

8. The electrode assembly of claim 1, further comprising a fixation member between the first metal foil and a corresponding one of the anode and the cathode.

9. The electrode assembly of claim 1, wherein each of the anode, the separator, and the cathode have a sheet shape, the anode and the cathode may be alternately and repeatedly stacked, and the separator may be positioned between the anode and the cathode.

10. The electrode assembly of claim 1, wherein the first metal foil is directly between the insulating layer and the separator.

11. The electrode assembly of claim 1, wherein the second metal foil of each of the first short-circuit member and the second short-circuit member faces and contacts an exterior of the electrode assembly.

12. The electrode assembly of claim 1, wherein edges of each the first short-circuit member and the second short-circuit member are bent toward the anode and the cathode, respectively.

13. A rechargeable lithium battery, comprising:
the electrode assembly as claimed in claim 1; and
a case receiving the electrode assembly and an electrolyte.
